(19) United States
(12) Patent Application Publication
(10) Pub. No.: US 2012/0308387 A1
(43) Pub. Date: Dec. 6, 2012

(54) Hybrid Drive Train for a Wind Turbine

(75) Inventors: Richard A. Himmelmann, Beloit, WI (US); Zbigniew Piech, Cheshire, CT (US); Richard N. Fargo, Plainville, CT (US)

(73) Assignee: Clipper Windpower, LLC, Carpinteria, CA (US)

(21) Appl. No.: 13/279,755

(22) Filed: Oct. 24, 2011

Related U.S. Application Data
(60) Provisional application No. 61/491,849, filed on May 31, 2011.

(51) Int. Cl. F03D 11/02; F16H 7/06; F16H 37/02

(52) U.S. Cl. 416/170 R; 74/730.1; 474/84; 475/31

(57) ABSTRACT

A distributed hybrid drive train for a wind turbine is disclosed. The drive train may include a first stage chain drive adapted to receive mechanical energy from a main shaft of a wind turbine and a second stage gearbox adapted to receive rotational mechanical energy from the first stage chain drive and transmitting the rotational mechanical energy to one or more generators of the wind turbine.

### CROSS-REFERENCE TO RELATED APPLICATION

This application is a Non-Provisional Patent application claiming priority under 35 U.S.C. §119(e) to U.S. Provisional Patent Application Ser. No. 61/491,849 filed on May 31, 2011, the entirety of which is incorporated by reference herein.

### FIELD OF THE DISCLOSURE

The present disclosure generally relates to wind turbines and, more particularly, relates to drive trains for transferring energy from a main shaft to one or more generators of wind turbines.

### BACKGROUND OF THE DISCLOSURE

A utility-scale wind turbine typically includes a set of two or three large rotor blades mounted to a hub. The rotor blades and the hub together are referred to as the rotor. The rotor blades aerodynamically interact with the wind and create lift, which is then translated into a driving torque by the rotor. The rotor is attached to and drives a main shaft, which in turn is operatively connected via a drive train to a generator or a set of generators that produce electric power.

Many types of drive trains are known for connecting the main shaft to the generator(s). One type of drive train uses various designs and types of speed increasing gearboxes to connect the main shaft to the generator(s). Typically, the gearboxes include one or more stages of gears and a large housing, wherein the stages increase the rotor speed to a speed that is more desirable for driving the generator(s). While effective, large forces translated through the gearbox can deflect the gearbox housing and components therein and displace the large gears an appreciable amount so that the alignment of meshing gear teeth can suffer. When operating with misaligned gear teeth, the meshing teeth can be damaged, resulting in a reduced lifespan. The large size of these gearboxes and the extreme loads handled by them make them even more susceptible to deflections and resultant premature wear and damage. Furthermore, maintenance and/or replacement of parts of damaged gearboxes may not only be difficult and expensive, it may require entire gearboxes to be lifted down from the wind turbine.

Some other drive trains are known as direct drive trains, wherein instead of a gearbox, a mechanical coupling is provided between the main shaft and a generator input shaft often in-line therewith or, alternatively, the generator is mounted as an integral part of the rotor hub assembly. US Patent Publication No. 2009/0026771, in the name of Bevington, is one example of such a direct drive. Direct drive trains are not only heavier than gearbox drive trains, they also utilize a larger quantity of rare earth elements, thereby increasing the cost of the overall drive train. The difficulty of maintenance and/or replacement of parts in direct drive trains is also compounded in comparison with gearbox drive trains due to the size of such drive trains.

Accordingly, it would be beneficial if an improved wind turbine drive train that is not as susceptible to damage from deflections in the gearbox and resultant misalignments of components is developed. It would additionally be beneficial if such a drive train were easily serviceable, did not weigh as much as traditional gearboxes and direct drive trains and were not as expensive to install, operate and maintain.

### SUMMARY OF THE DISCLOSURE

In accordance with one aspect of the present disclosure, a drive train for a wind turbine is disclosed. The drive train may include a first stage chain drive adapted to receive mechanical energy from a main shaft of a wind turbine and a second stage gearbox adapted to receive rotational mechanical energy from the first stage chain drive and transmitting the rotational mechanical energy to one or more generators of the wind turbine.

In accordance with another aspect of the present disclosure, a wind turbine is disclosed. The wind turbine may include a hub, a plurality of blades radially extending from the hub, a main shaft rotating with the hub, a first stage drive adapted to receive mechanical energy from the main shaft, the first stage drive including a first stage drive sprocket, at least one drive strand, and at least one first stage driven sprocket, the at least one drive strand trained around the first stage drive sprocket and driving the at least one first stage driven sprocket and a second stage gearbox adapted to receive rotational mechanical energy from the at least one first stage driven sprocket and transmitting the rotational mechanical energy to one or more generators connected to the second stage gearbox.

In accordance with yet another aspect of the present disclosure, a wind turbine is disclosed. The wind turbine may include a hub, a main shaft rotating with the hub and a drive train connected to the main shaft. The drive train may further include (a) a first stage operatively connected to the main shaft, the first stage increasing speed relative to the main shaft and decreasing torque and including a first stage drive sprocket having a plurality of segments, a plurality of drive strands, and a plurality of first stage driven sprockets, with one of the plurality of drive strands trained around each of the plurality of segments and transferring rotation to one of the plurality of first stage driven sprockets; and (b) a second stage operatively connected to the first stage, the second stage increasing speed relative to the first stage and decreasing torque relative to the first stage.

Other advantages and features will be apparent from the following detailed description when read in conjunction with the attached drawings.

### BRIEF DESCRIPTION OF THE DRAWINGS

For a more complete understanding of the disclosed methods and apparatuses, reference should be made to the embodiments illustrated in greater detail on the accompanying drawings, wherein:

FIG. 1 is a schematic illustration of a wind turbine, in accordance with at least some embodiments of the present disclosure;

FIG. 2 is a schematic illustration of an exemplary drive train that may be employed within the wind turbine of FIG. 1;

FIG. 3 is a perspective view of a sprocket employed within the exemplary drive train of FIG. 2; and

FIGS. 4-6 show maintenance features of the exemplary drive train of FIG. 2.

While the following detailed description has been given and will be provided with respect to certain specific embodiments, it is to be understood that the scope of the disclosure should not be limited to such embodiments, but that the same are provided simply for enablement and best mode purposes. The breadth and spirit of the present disclosure is broader than the embodiments specifically disclosed and encompassed within the claims eventually appended hereto.

### DETAILED DESCRIPTION OF THE DISCLOSURE

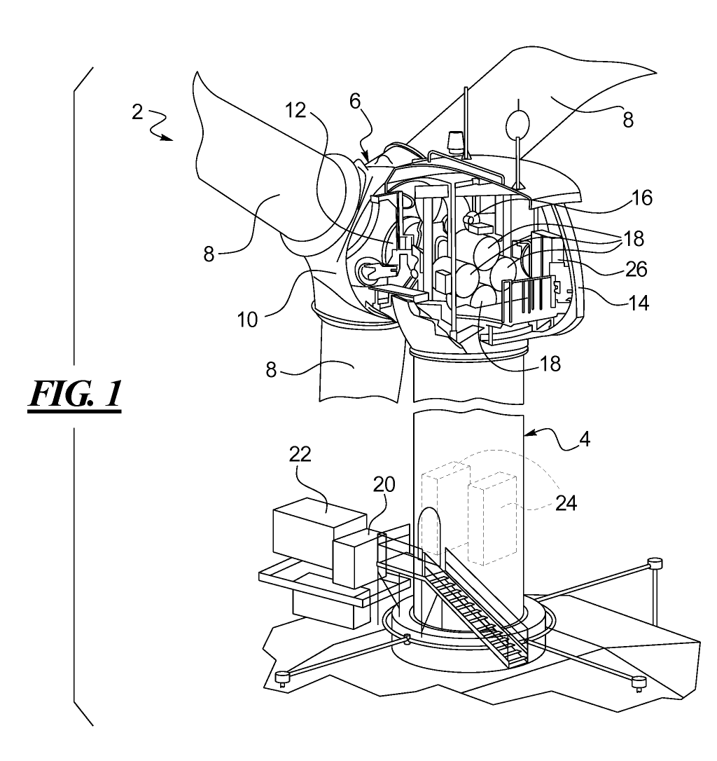

Referring to FIG. 1, an exemplary wind turbine 2 is shown, in accordance with at least some embodiments of the present disclosure. While all the components of the wind turbine have not been shown and/or described, a typical wind turbine may include a tower section 4 and a rotor 6. The rotor 6 may include a plurality of blades 8 connected to a hub 10. The blades 8 may rotate with wind energy and the rotor 6 may transfer that energy to a main shaft 12 situated within a nacelle 14. The nacelle 14 may additionally include a drive train 16, which may connect the main shaft 12 on one end to one or more generators 18 on the other end. The generators 18 may generate power, which may be transmitted through the tower section 4 to a power distribution panel (PDP) 20 and a pad mount transformer (PMT) 22 for transmission to a grid (not shown). Specifically, power from the generators 18 may be transmitted to inverters/converters situated within one or more generator control units (GCU) 24 positioned within the tower section 4, which in turn may transmit that power to the PDP 20 and the PMT 22. The GCUs 24 and other components within the wind turbine 2 may be operated under control by a turbine control unit (TCU) 26 situated within the nacelle 14.

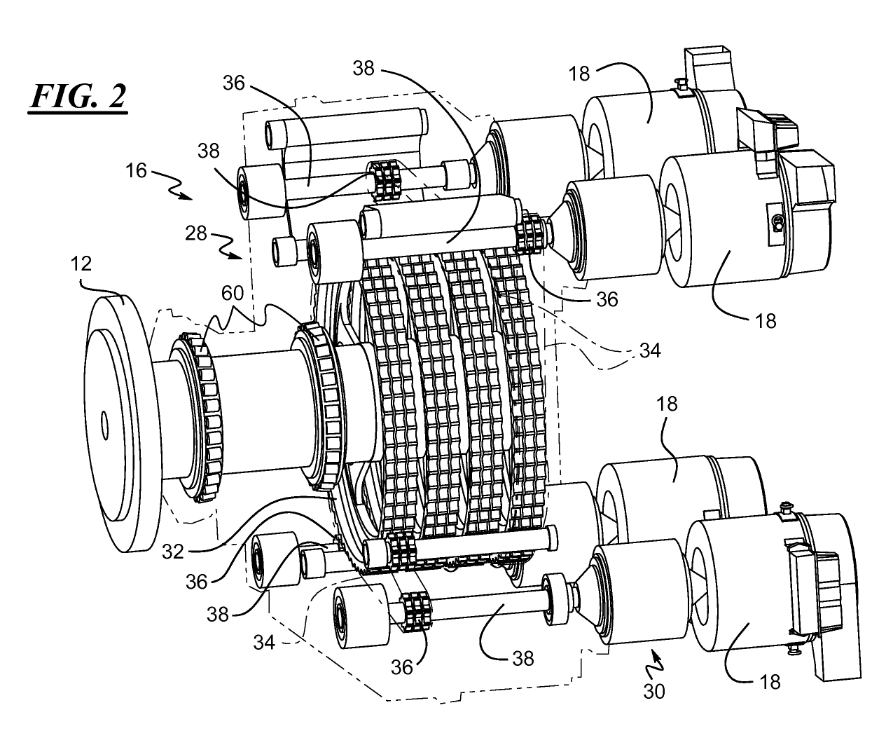

Referring now to FIG. 2, a schematic illustration of the drive train 16 is shown, in accordance with at least some embodiments of the present disclosure. As shown, the drive train 16 may be a dual stage hybrid drive train having a first stage 28 of one or more chain drives connected to the main shaft 12 and the first stage leading to a second stage 30 of one or more single stage or multi-stage gearboxes connected to the generators 18, both stages being discussed in greater detail below. As will be further discussed further below, in at least some embodiments, more than one of the first stage 28 and the second stage 30 may be employed.

With respect to the first stage 28 in particular, it may include a first stage drive sprocket 32 that may be driven by the main shaft 12, which in turn may be driven by the rotation of the blades 8. The first stage drive sprocket 32 may engage a plurality of chain strands (also referred to herein as low speed chain strands) 34 and each of the chain strands may be trained around to further drive one of a first stage driven sprocket (also referred to herein as low speed sprocket) 36. If a belt drive is desired instead of a chain drive, belt strands may be substituted for the chain strands 34, and belt strands may be substituted in any instance where chain strands are described in this specification, as will be understood by those of ordinary skill in this art. In the claims that are appended hereto “strand” may refer to any appropriate type of chain strand or any appropriate type of belt strand. Furthermore, notwithstanding the fact that in the present embodiment, the plurality of chain strands 34 are employed for driving the first stage driven sprockets 36, in at least some embodiments, a single long chain may be employed in lieu of the plurality of chain strands to drive the first stage driven sprockets. Furthermore, in at least some embodiments, each of first stage driven sprockets 36 may be smaller in size compared to the first stage drive sprocket 32. Each of the first stage driven sprockets 36 may in turn drive an intermediate shaft 38, which may be connected to one or more gearboxes of the second stage 30, as described further below. By virtue of providing the first stage drive sprocket 32 engaging the plurality of chain strands 34 and each of the plurality of chain strands driving one of the first stage driven sprockets 36, torque from the rotor 6 may be split and distributed into multiple pathways. Splitting torque into multiple pathways provides several advantages, such as, reducing the size, cost, and complexity of downstream components in the drive train 16 because they handle a smaller torque.

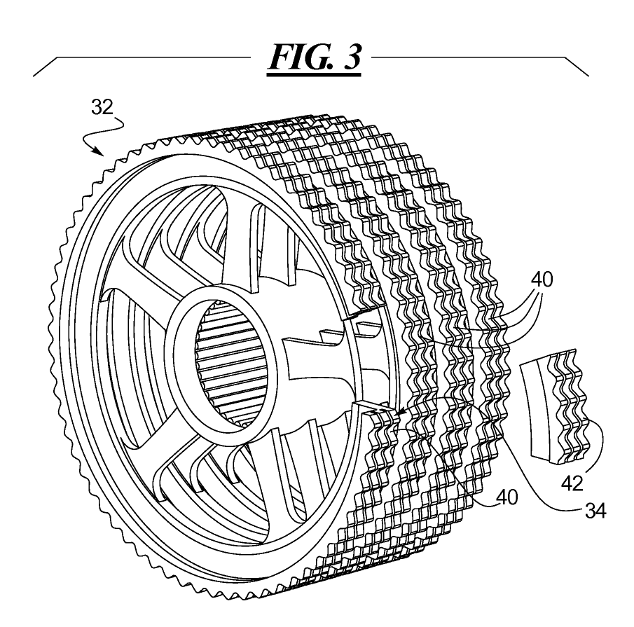

In at least some embodiments, the first stage drive sprocket 32, as shown in greater detail in FIG. 3, may be a segmented sprocket mounted onto the main shaft 12. Depending upon the number of the multiple pathways to split the torque into, the first stage drive sprocket may have multiple segments. For example, in at least some embodiments and, as shown, the first stage drive sprocket 32 may have four segments 40 for splitting the torque into four different pathways and each of the four segments may engage one of the plurality of chain strands 34 and each of the plurality of chain strands may drive one of the first stage driven sprockets 36. Thus, for splitting the torque into four pathways, four of the segments 40 of the first stage drive sprocket 32 engaging four of the plurality of chain strands 34 and four of the first stage driven sprockets 36 may be employed.

It will be understood that although in the present embodiment, the torque has been split and distributed into four pathways, this is merely exemplary and may depend upon several factors. For example, in at least some embodiments, the number of torque pathways may depend upon the number of generators 18 employed, such that for four generators as shown, four torque pathways may be employed. In other embodiments, the number of torque pathways may depend upon the size and capabilities of each of the components, such as, the first stage drive sprocket 32, the plurality of chain strands 34, each of the first stage driven sprockets 36 and the gearboxes of the second stage 30. In alternate embodiments, other parameters may be employed for determining the number of torque pathways.

Accordingly, the drive train 16 may be termed a distributed torque drive train that divides and reduces the torque output from the main shaft 12 into multiple path ways by way of the first stage drive sprocket 32 and the four first stage driven sprockets 36. In other embodiments, the number of the segments 40 in the first stage drive sprocket 32 and the number of the first stage driven sprockets 36 may vary to greater than four or possibly even less than four depending upon the torque separation desired. By virtue of positioning the first stage driven sprockets 36 (and the four intermediate shafts 38) symmetrically about a rotational axis of the main shaft 12, loads on the main shaft may be balanced, thereby providing a balanced drive train and a balanced main shaft. “Symmetrical” as used herein to describe the relative positioning of the first stage driven sprockets 36 and the intermediate shafts 38 relative to the main shaft 12 means that the positioning of these components creates complementary forces on the main shaft 12 that somewhat cancel one another out. By splitting torque in the manner described above and by engaging four of the plurality of chain strands 34 with four of the symmetrically positioned first stage driven sprockets 36, the tension in the chain strands 34 may exert a reaction force back onto the first stage drive sprocket, such that sum of the forces on the first stage drive sprocket may somewhat cancel one another, thereby resulting in effect a reduction of the overall forces on the main shaft 12 that are reacted by main shaft bearings 60. Reducing forces required to be reacted by the main shaft bearings 60 is important in ensuring the longevity of the drive train 16 and/or reducing the cost of the bearings.

The size, shape and weight of each of the first stage drive sprocket 32, the plurality of chain strands 34 and each of the first stage driven sprockets 36 may vary depending upon the size and power of the rotor 6. Thus, in at least some embodiments, for the rotor 6 rotating at 13.5 rotations per minute (13.5 rpm) and generating 2.78 Mega Watts (2.78 MW) of energy, the first stage drive sprocket 32 may be a 2.47 meter (97.24 inches) diameter segmented sprocket and having 102×0.08 meters (3 inches) pitch teeth. In addition, each segment 42 (See FIG. 3) of the first stage drive sprocket 32 may be a seventy four pound mass segment (74 lbm). Relatedly, each of the plurality of chain strands 34 may be a simplex or duplex 240 standard 2031 kilonewtons (2031 kN) chain having three strands and four paths In at least some embodiments, one or more of the plurality of chain strands 34 may be roller chains, silent chains, high efficiency chains, toothed cables, toothed belts, V-belts and the like. Each of the first stage driven sprockets 36 in turn may be a 0.27 meter (10.63 inches) diameter sprocket having 11×0.08 meters (3 inches) pitch teeth and a 9.31:1 gear ratio. In other embodiments, one or more of the parameters of the first stage drive sprocket 32, the plurality of chain strands 34 and the first stage driven sprockets 36 may vary from those described above. Various idlers and other components, although not described, may also be included to ensure proper tensioning of the plurality of chain strands 34 and proper contact of the plurality of chain strands with the teeth of the first stage drive sprocket 32 and the first stage driven sprockets 36.

With respect to the second stage 30, in at least some embodiments, it may include a set of gearboxes 44, each of which may be connected to and driven by one of the intermediate speed shafts 38. Each of the gearboxes 44 in turn may be further connected, either directly or through a high speed shaft, to drive one of the one or more generators 18. Thus, each of the plurality of chain strands 34 drives each of the first stage driven sprockets 36, which in turn drives each of the intermediate speed shafts 38, which further drive each of the gearboxes 44. Accordingly, for splitting the torque into four torque pathways, four of the gearboxes 44 may be employed to be driven by four of the intermediate speed shafts 38. Similar to the first stage driven sprockets 36 and the intermediate speed shafts 38, the gearboxes 44 and the generators 18 may be oriented symmetrically around the rotational axis or the central axis of the main shaft 12, or they may be oriented asymmetrically about the main shaft 12.

Furthermore, each of the gearboxes 44 may be any of a variety of single stage or multi stage gearboxes that may be deemed suitable for use within the wind turbine 2. For example, in at least some embodiments, each of the gearboxes 44 may be a planetary gearbox. In other embodiments, one or more of the gearboxes 44 may be any of a sliding mesh gearbox, a constant mesh gearbox, a synchromesh gearbox and/or a continuously variable transmission (CVT) gearbox. Moreover, as discussed above, each of the gearboxes 44 may have one or more stages of gears therewithin. By virtue of utilizing four of the gearboxes 44 and four of the generators 18 in the second stage 30 of the drive train 16, torque may be further reduced while the speed of the generators may be further increased by the gearboxes.

Notwithstanding the fact that in the present embodiment, one of the first stage 28 having one or more chain drives and one of the second stage 30 having one or more gearboxes have been described above, it will be understood that this is merely exemplary. In other embodiments, more than one stage of the chain drives and/or more than one stage of the gearboxes may be employed, depending upon the torque reduction and the speed increase desired. In alternate embodiments, only one or more stages of the chain drive may be employed. Furthermore, although in the present embodiment, four of the generators 18 have been employed, in at least some other embodiments, the number of generators may vary depending upon the number of first stage driven sprockets 36 and the second stage gearboxes 44. In at least some other embodiments, a single generator connected to all of the gearboxes 44 (or possibly even directly connected to the first stage driven sprockets 36 in case of a single stage chain drive) may also be employed. In yet other embodiments, more than one of the generators 18 connected to each of the gearboxes 44 (or the first stage driven sprockets 36) or alternatively, one generator connected to more than one of the gearboxes (or the first stage driven sprockets) may be employed.

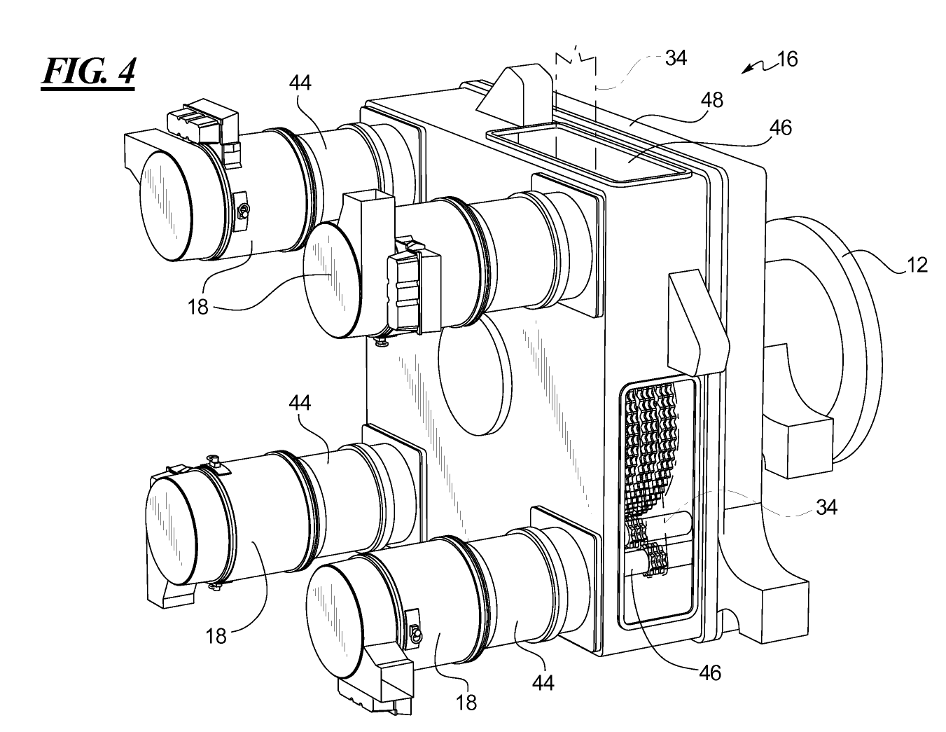

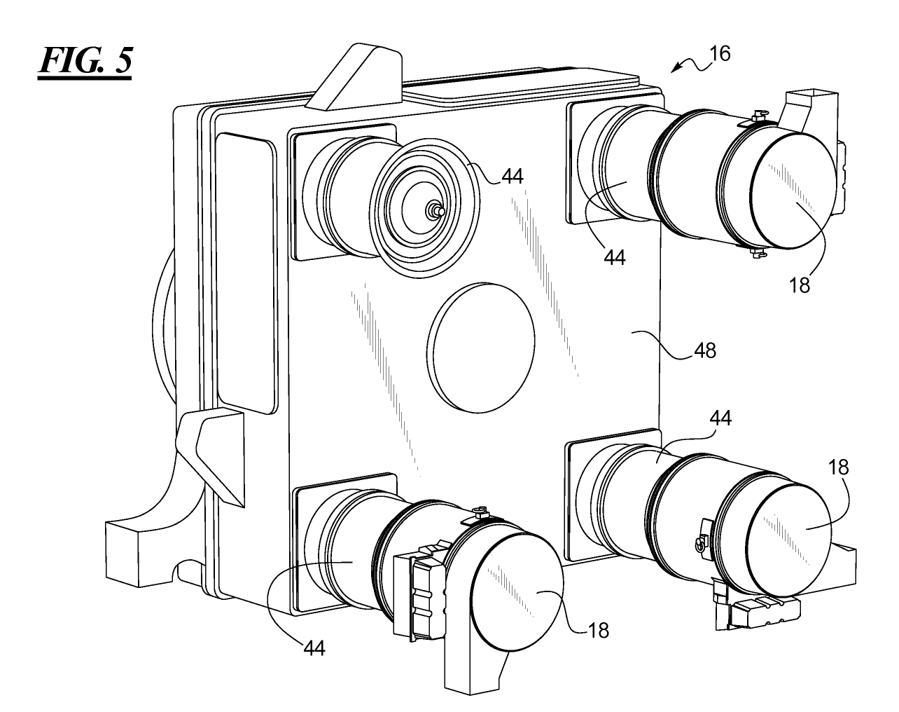

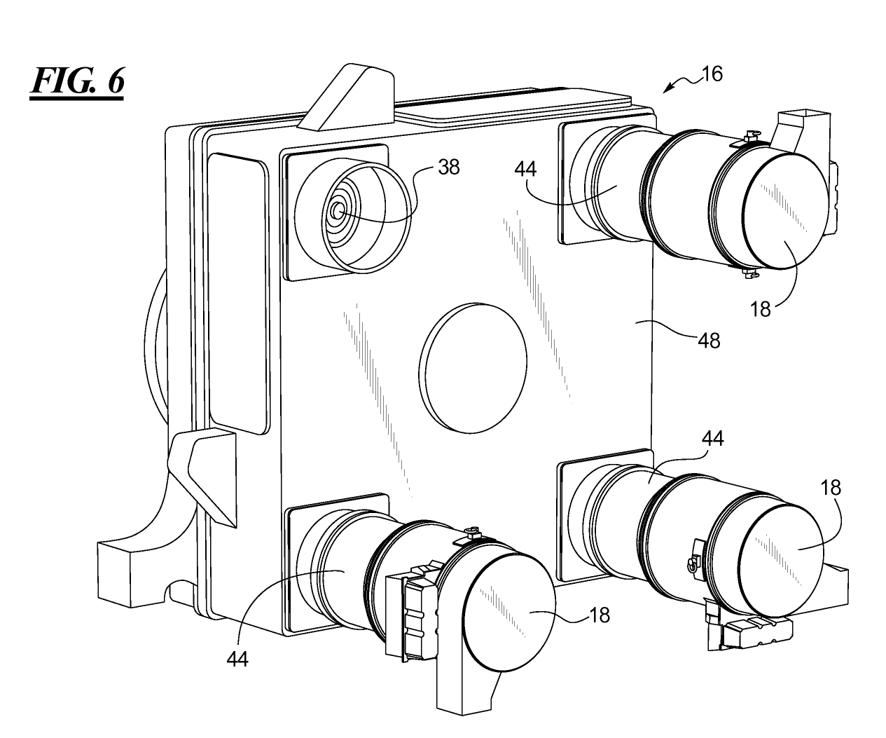

Referring now to FIGS. 4-6, various schematic illustrations showing maintenance features of the first stage 28 and the second stage 30 are shown, in accordance with at least some embodiments of the present disclosure. Specifically, FIG. 4 shows servicing of the first stage 28, while FIGS. 5 and 6 show servicing of one of the second stage 30. Referring now particularly to FIG. 4, one or more of the plurality of chain strands 34 of the first stage 28 may be serviced by opening one or both covers 46 of housing 48 and then pulling apart the one of the plurality of chain strands that needs to be serviced. The one of the plurality of chain strands 34 that needs servicing may be removed by disconnecting one of the links of that respective chain strand and pulling away from the first stage drive sprocket 32 and the first stage driven sprockets 36. Similarly, although not shown, the first stage drive sprocket 32, any of the first stage driven sprockets 36 and/or any of the intermediate speed shafts 38 may be serviced by removing those components after dismantling the associated one of the plurality of chain strands 34 in a manner described above.

Turning to FIGS. 5 and 6, servicing of the second stage 30 and, particularly, servicing of the gearbox 44 is shown. As shown in FIG. 5, in order to service any one of the gearboxes 44, the generator 18 connected to that particular gearbox may be first removed, thereby exposing the gearbox. Next, as shown in FIG. 6, the exposed gearbox may be removed from the intermediate speed shaft 38 to service that gearbox.

Upon removing the components from the first stage 28 or the second stage 30 that needs servicing from the drive train 16, those relatively lightweight and small components (as compared to traditional gearbox and direct drive components) may be easily lowered from the tower section 4 of the wind turbine 2 by an onboard hoist and replaced with new components. The replaced components may then be hoisted back up to the nacelle 14 and installed back into position.

### INDUSTRIAL APPLICABILITY

In general, the present disclosure sets forth a distributed hybrid drive train that employs a first stage of a chain drive and a second stage of a gearbox to reduce torque and increase rotor speed from the main shaft to the generators. The first stage may include a first stage drive sprocket, which may engage a plurality of chain strands, each of the plurality of chain strands may drive a smaller first stage driven sprocket connected to an intermediate speed shaft. Each of the intermediate speed shafts may in turn be connected to a gearbox in the second stage. Thus, driving the first stage driven sprocket may drive the intermediate speed shafts, which in turn may drive the gearboxes of the second stage to drive the generators for generating power. Because of the difference in the number of sprocket teeth between the first stage drive sprocket and the smaller first stage driven sprockets, and speed increasing gearboxes in the second stage, each stage achieves a speed increase and torque decrease. The split of torque into four separate paths culminating in four separate generators further helps to reduce the torque.

Such a hybrid drive train advantageously provides one deflection resilient first stage chain drive, and a second stage with a long life, high efficiency gearbox. Furthermore, by utilizing a first stage chain drive and by splitting the torque into multiple pathways, smaller gearboxes may be used in the second stage and smaller, light weight and low cost generators (roughly one fifth of the size of direct drive generators) may be employed.

Also, the hybrid drive train described above is highly serviceable in comparison with conventional drive trains given the smaller parts of the hybrid drive train, which may be serviced easily with an on board hoist without requiring any special hauling equipment to remove heavy equipment from the wind turbine. Additionally, by employing sprockets and multiple chain strands, the torque capability may be increased, since chains, sprockets and idlers are inherently more tolerant of torque deflections than gearboxes. Moreover, the sprocket and chain drives are resilient to misalignment of the driver and driven sprockets. Any misalignments may be tolerated in part by the flexibility of the chains, and do not significantly reduce the overall lifespan on the sprockets and chains.

While only certain embodiments have been set forth, alternatives and modifications will be apparent from the above description to those skilled in the art. These and other alternatives are considered equivalents and within the spirit and scope of this disclosure and the appended claims.

We claim:

1. A drive train for a wind turbine, comprising:
a first stage chain drive adapted to receive mechanical energy from a main shaft of a wind turbine; and
a second stage gearbox adapted to receive rotational mechanical energy from the first stage chain drive and transmitting the rotational mechanical energy to one or more generators of the wind turbine.

2. The drive train of claim 1, wherein the first stage chain drive increases speed and decreases torque.

3. The drive train of claim 1, wherein the second stage gearbox increases speed and decreases torque.

4. The drive train of claim 1, wherein the first stage chain drive comprises a plurality of first stage driven sprockets, each of the first stage driven sprockets mounted symmetrically around a rotational axis of the main shaft.

5. The drive train of claim 4, wherein each of the plurality of first stage driven sprockets is driven by one of a plurality of chain strands, each of the plurality of chain strands engaged by a first stage drive sprocket mounted onto the main shaft.

6. The drive train of claim 5, wherein the plurality of first stage driven sprockets comprises four sprockets and the plurality of chain strands comprises four chains.

7. The drive train of claim 4, wherein each of the plurality of first stage driven sprockets drives an intermediate speed shaft connecting the first stage chain drive to the second stage gearbox.

8. The drive train of claim 1, wherein the second stage gearbox comprises a plurality of gearboxes, each of the plurality of gearboxes connected at least indirectly to a plurality of first stage driven sprockets of the first stage chain drive.

9. The drive train of claim 9, wherein each of the plurality of gearboxes is a planetary gearbox.

10. The drive train of claim 9, wherein each of the plurality of gearboxes is directly coupled to one of the one or more generators.

11. The drive train of claim 1, wherein the first stage chain drive comprises a first stage drive sprocket mounted on the main shaft and engaging at least one chain strand, the at least one chain strand trained around at least one first stage driven sprocket.

12. A wind turbine, comprising:
a hub;
a plurality of blades radially extending from the hub;
a main shaft rotating with the hub;
a first stage drive adapted to receive mechanical energy from the main shaft, the first stage drive including a first stage drive sprocket, at least one drive strand, and at least one first stage driven sprocket, the at least one drive strand trained around the first stage drive sprocket and driving the at least one first stage driven sprocket; and
a second stage gearbox adapted to receive rotational mechanical energy from the at least one first stage driven sprocket and transmitting the rotational mechanical energy to one or more generators connected to the second stage gearbox.

13. The wind turbine of claim 12, wherein the at least one drive strand includes four chain strands and the at least one driven sprocket includes four first stage driven sprockets, each of the four first stage sprockets being driven by one of the four chain strands.

14. The wind turbine of claim 13, wherein the first stage drive sprocket is a segmented sprocket.

15. The wind turbine of claim 12, wherein the second stage gearbox comprises four gearboxes, each of the gearboxes driven by one of four intermediate speed shafts, each of the four gearboxes driving one of the one or more generators.

16. The wind turbine of claim 15, wherein each of the four first stage driven sprockets, each of the four intermediate speed shafts and each of the four gearboxes are symmetrically oriented around the main shaft.

17. The wind turbine of claim 12, wherein the first stage chain drive splits torque into four pathways.

18. A wind turbine, comprising:
a hub;
a main shaft rotating with the hub; and
a drive train connected to the main shaft, the drive train comprising (a) a first stage operatively connected to the main shaft, the first stage increasing speed relative to the main shaft and decreasing torque and including a first stage drive sprocket having a plurality of segments, a plurality of drive strands, and a plurality of first stage driven sprockets, with one of the plurality of drive strands trained around each of the plurality of segments and transferring rotation to one of the plurality of first stage driven sprockets; and (b) a second stage operatively connected to the first stage, the second stage increasing speed relative to the first stage and decreasing torque relative to the first stage.

19. The wind turbine of claim 18, wherein the second stage includes a plurality of gearboxes, with each of the gearboxes being operatively connected to one of the plurality of first stage driven sprockets.

20. The wind turbine of claim 19, wherein the plurality of drive strands comprises a plurality of chain strands.
